(19) United States
(12) Patent Application Publication
(10) Pub. No.: US 2014/0258891 A1
(43) Pub. Date: Sep. 11, 2014

(54) ELECTRONIC DEVICE, STORAGE MEDIUM AND METHOD FOR PROCESSING INFORMATION

(71) Applicant: TENCENT TECHNOLOGY (SHENZHEN) COMPANY LIMITED, Shenzhen City (CN)

(72) Inventors: WEN-JUN GAO, Shenzhen City (CN); MING HE, Shenzhen City (CN); LEI CHEN, Shenzhen City (CN); CAN SHEN, Shenzhen City (CN); SHI ZHEN, Shenzhen City (CN)

(73) Assignee: TENCENT TECHNOLOGY (SHENZHEN) COMPANY LIMITED, Shenzhen City (CN)

(21) Appl. No.: 14/280,566

(22) Filed: May 16, 2014

Related U.S. Application Data
(63) Continuation of application No. PCT/CN2012/084065, filed on Nov. 5, 2012.

(30) Foreign Application Priority Data
Nov. 25, 2011 (CN) 201110382448.0

(51) Int. Cl. G06F 9/54

(52) U.S. Cl. CPC G06F 9/547
USPC 715/760

(57) ABSTRACT

The present invention discloses an electronic device, a storage medium, and a method for processing information. The method includes: a browser receiving non-processed information, and calling a corresponding browser plugin according to a type of the non-processed information; and the browser calling a corresponding third-party software through the browser plug-in, and processing the non-processed information using the third-party software. By using the above method, the scope of the information that the browser can process is expanded, and the information processing capability of the browser is also improved.

### CROSS REFERENCE

The application is a U.S. continuation application under 35 U.S.C. §111(a) claiming priority under 35 U.S.C. §120 and 365(c) to International Application No. PCT/CN2012/084065 filed Nov. 5, 2012, which claims the priority benefit of CN patent application serial No. 201110382448.0, titled “method for processing information, browsing device and storage medium” and filed on Nov. 25, 2011, the contents of which are incorporated by reference herein in their entirety for all intended purposes.

### TECHNICAL FIELD

The present invention relates to computer technology, and more particularly to an electronic device, a storage medium and a method for processing information.

### BACKGROUND

With the development of diversified functionalities, cellular phones are not only used as mobile phones. People can obtain a variety of information by browsing webpage with a browser in the mobile phones. The browser needs to process information to achieve corresponding functions. For example, the browser processes the information to load webpages.

When processing information, the existing browser judges whether the received information is webpage information; if yes, the browser processes the received information; if no, the browser could call embedded browser plugins to process the received information indirectly.

In the process of inventing the present invention, the inventors have found that the known art exists at least the following problems.

The browser in the known art needs to call the browser plugins to process the information if the information is non-webpage information. If the browser plugins cannot process the non-webpage information, the browser also cannot process the non-webpage information. As a result, the scope of the information that can be processed by the browser is limited, this leads to the browser is also limited a bit when processing information, the ability of processing information is not so high, and this affects the normal use of the users.

### SUMMARY

To expand the scope of information that the browser processes, and improve the capacity of the browser for processing information, the present invention provides an electronic device, a storage medium and a method for processing information. The technical solutions are described as follows.

In one aspect, a method for processing information is provided. The method is configured for being performed by a browser. The method includes:

receiving non-processed information from a server;

calling a corresponding browser plugin according to a type of the non-processed information;

calling a corresponding third-party software through the browser plugin; and

processing the non-processed information using the third-party software.

In another aspect, an electronic device for browsing information from a server is also provided. The electronic device includes memory, one or more processors, and one or more modules stored in the memory and configured for execution by the one or more processors, the one or more modules include:

a receiving module, configured for receiving non-processed information from a server;

a first calling module, configured for calling a corresponding browser plugin according to a type of the non-processed information received by the receiving module; and

a second calling module, configured for calling a corresponding third-party software through the browser plugin called by the first calling module, and processing the non-processed information using the third-party software.

In yet another aspect, a computer readable storage medium storing one or more programs is also provided. The one or more programs comprising instructions, which can be executed by an electronic device, cause the electronic device to perform a method including:

receiving non-processed information from a server;

calling a corresponding browser plugin according to a type of the non-processed information;

calling a corresponding third-party software through the browser plugin; and

processing the non-processed information using the third-party software.

The technical solutions provided by the embodiments of the present invention have the following advantages. The browser calls a third-party software through a browser plugin, and submits complex non-webpage information cannot be processed by the browser to the third-party software for processing, and this method expands the scope of the information can be processed by the browser, and improves the information processing capability of the browser. Furthermore, the third-party software and the browser are independent from each other, a size of an installation package of the browser can be reduced, and the health degree of the third-party software can also be improved. Additionally, the interaction of the browser plugin and the third-party software improves the mutual viscous of the third-party software and the browser, as a result, the third-party software get more exposure under the support of the browser.

### DESCRIPTION OF THE DRAWINGS

In order to describe technical solutions of embodiments of the present inventions more clearly, the accompanying drawings required for describing the embodiments are briefly introduced hereinafter. It is apparent that the accompanying drawings are only used for illustrating some of the embodiments of the present invention, and for those ordinarily skilled in the art, further drawings can be realized without additional inventive efforts.

FIG. 1 is a schematic diagram of an exemplary environment of each embodiment of the present invention.

FIG. 2 is a flowchart illustrating a method for processing information provided by embodiment 1 of the present invention;

FIG. 3 is a flowchart illustrating a method for processing information provided by embodiment 2 of the present invention;

FIG. 4 is a schematic diagram illustrating an interface of a home page of a browser provided in embodiment 3 of the present invention;

FIG. 5 is a flowchart illustrating a method for processing information provided by embodiment 3 of the present invention;

FIG. 6 is a block diagram of a browser provided by embodiment 4 of the present invention;

FIG. 7 is block diagram of another browser provided by embodiment 4 of the present invention;

FIG. 8 is block diagram of yet another browser provided by embodiment 4 of the present invention.

### DETAILED DESCRIPTION OF PREFERRED EMBODIMENTS

To describe the object, the technical solutions and the advantages of the present invention more clearly, embodiments of the present invention are described in detail accompanying with drawings as follows.

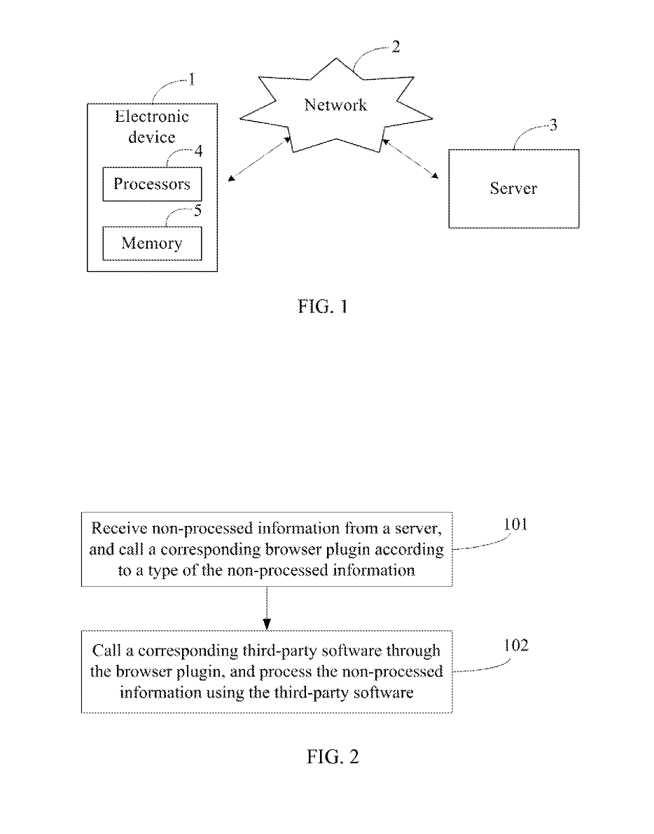

FIG. 1 is a schematic diagram of an exemplary environment of each embodiment of the present invention. The exemplary environment may include an electronic device 1, a network 2 and a server 3. The electronic device 1 and the server 3 may be coupled through the network 2 for information exchange, such as sending/receiving files such as images, documents, videos, etc. Although only one electronic device 110 and one target device 120 are shown in the environment, any number of terminals or servers may be included, and other devices may also be included.

The network 2 may include any appropriate type of communication network for providing network connections to the electronic device 1 and the server 3. For example, the network 2 may include the Internet or other types of computer networks or telecommunication networks, either wired or wireless.

In some cases, the electronic device 1 may refer to any appropriate user terminal with certain computing capabilities, such as a person computer (PC), a work station computer, a server computer, a hand-held computing device (tablet), a smart phone or mobile phone.

An exemplary computing system for the electronic device 1 may include one or more processors 4 and a memory 5. The processors 4 may include any appropriate processor or processors. Further, the processors 4 can include multiple cores for multi-thread or parallel processing. The memory 5 may include memory modules, such as ROM, RAM, and flash memory modules, and mass storages, such as CD-ROM, U-disk, removable hard disk, etc. The memory 5 is non-transitory computer readable. The memory 5 may store computer programs for implementing various processes, when executed by processor.

### Embodiment 1

Referring to FIG. 2, the present embodiment provides a method for processing information. The method is configured for being performed by a browser. The browser is running in the electronic device 1 for browsing information from the server 3. The method includes the following steps:

101: receiving non-processed information from the server 3, and calling a corresponding browser plugin according to a type of the non-processed information;

102: calling a corresponding third-party software through the browser plugin, and processing the non-processed information using the third-party software.

Before calling the corresponding browser plugin according to the type of the non-processed information, the method further includes:

The browser judges whether the browser is capable of processing the non-processed information;

If the browser is capable of processing the non-processed information, the browser processes the non-processed information;

If the browser is not capable of processing the non-processed information, performs the step of calling the corresponding browser plugin according to the type of the non-processed information.

Specifically, the step that the browser judges whether the browser is capable of processing the non-processed information includes the following steps:

The browser judges whether the type of the non-processed information is webpage information; if the type of the non-processed information is the webpage information, the browser judges that the browser is capable of processing the non-processed information.

Furthermore, before calling a corresponding third-party software through the browser plugin, the method further includes the following steps:

The browser plugin judges whether the browser plugin is capable of processing the non-processed information;

If the browser plugin is capable of processing the non-processed information, the non-processed information is processed by the browsing device plugin;

If the browser plugin is not capable of processing the non-processed information, the step of calling the corresponding third-party software through the browser plug-in is performed.

In addition, the third-party software is embedded in the browser.

Preferably, the third-party software is independent from the browser.

According to the method of the present embodiment, the browser calls a third-party software through a browser plug-in, and submits complex non-webpage information cannot be processed by the browser to the third-party software for processing, and this method expands the scope of the information can be processed by the browser, and improves the information processing capability of the browser. Furthermore, the third-party software and the browser are independent from each other, a size of an installation package of the browser can be reduced, and the health degree of the third-party software can also be improved. Additionally, the interaction of the browser plugin and the third-party software improves the mutual viscous of the third-party software and the browser, as a result, the third-party software get more exposure under the support of the browser.

For describing the method provided by the present embodiment in more detail, hereinafter, combining with the above description, the method provided by the present embodiment is described in detail according to embodiment 2 and embodiment 3 as follows:

### Embodiment 2

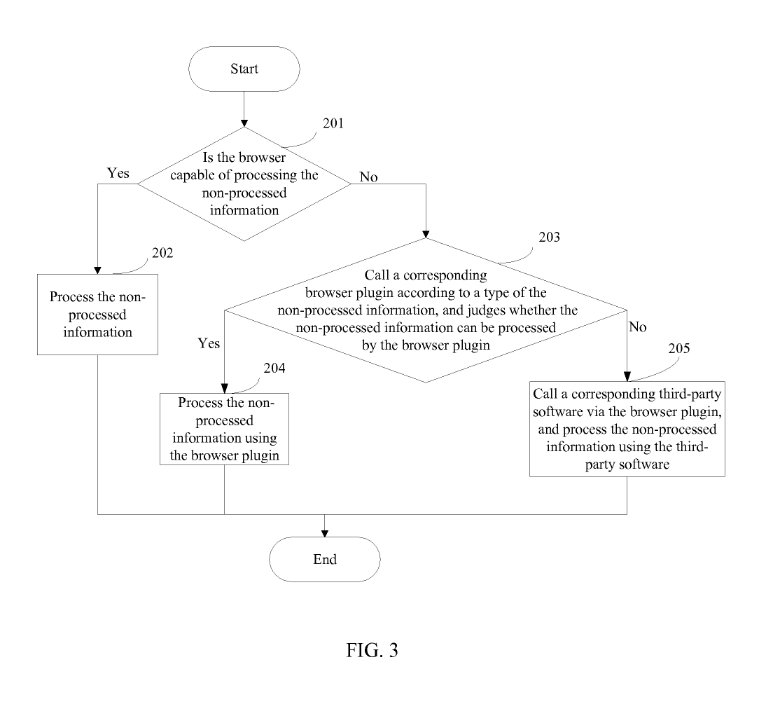

Referring to FIG. 3, the present embodiment provides a method for processing information. The method is configured for being performed by a browser. The browser is running in the electronic device 1 for browsing information from the server 3. The flow of the method includes following steps:

201: judging whether the browser is capable of processing received non-processed information from the server 3. If the browser is capable of processing the non-processed information, a step 202 is executed. Otherwise, a step 203 is executed.

The step 201 is optional. The browser is a kind of software that is configured for displaying documents in a web server or a file system, and performing interaction between users and the documents. Concretely, the browser interacts with the web server and obtains webpage via hypertext transfer protocol. Therefore, the browser processes webpage information interacting with the web server via network transfer protocols.

When the browser establishes a connection to the server 3, the browser sends an independent data request of link to the server 3 in the background automatically, and receives an encrypted packet with a data type sent from the server 3. Information in the encrypted packet refers to the non-processed information. When the browser processes the non-processed information, the browser could judges whether the browser is capable of processing the non-processed information at first. A specific way of judging whether the browser is capable of processing the non-processed information includes the following steps. The browser decrypts the data type of the received packet, and then judges whether the non-processed information is webpage information. If the non-processed information is webpage information, the browser is capable of processing the non-processed information, a step 202 is executed. If the non-processed information is non-webpage information, a step 203 is executed. In addition, except judging whether the browser is capable of processing the non-processed information by judging whether the non-processed information is webpage information, other methods can also be employed, and the method are not limited in the present embodiment.

When judging the non-processed information is webpage information, the webpage information may be information that conforms to webpage format. As the browser processes webpage information interacting with the web server via network transfer protocols, thus the existing technologies for judging whether the non-processed information is webpage information is very mature, and is not limited in the present embodiment.

202: processing the non-processed information via the browser, and the process ends.

Specifically, because the browser can process the webpage information interacting with the web server via the network transfer protocols, therefore, after the browser judges that the non-processed information is webpage information, the browser can process the non-processed information directly. The existing technologies that the browser used to process the webpage information are very mature, and the detail process that the browser how to process the non-process information is not described here for a purpose of brief description in the present embodiment.

203: calling a corresponding browser plugin according to a type of the non-processed information, and judging whether the browser plugin is capable of processing the non-processed information. If the browser plugin is capable of processing the non-processed information, a step 204 is executed; otherwise, a step 205 is executed.

Additionally, the step of the browser plugin judging whether the browser plugin is capable of processing the non-processed information is optional. The browser plugin is a widget program provided by a third-party software according to certain application programming interface specification, and is embedded in the browser. The function of the browser plugin is to process non-webpage information that cannot be processed by the browser. The browser provides a loading way for the browser plugin, so that the browser plugin can be loaded into the applications and the network transfer protocols, and exchange data with the browser. The browser plugin may be started when the browser starts, or started by the browser when the browser calls the browser plugin, or started and closed by the users at any time. Ways to start the browser plugin are not limited in the present embodiment.

After the browser decrypts the encrypted packet, which is sent by the server 3 and received by the browser, and ascertains the packet type, the browser calls the corresponding browser plugin according to the packet type. If more than one browser plugins embedded in the browser are capable of processing the non-processed information of the type, the browser may call a default browser plugin for processing the non-processed information of the type. However, the browser plugin is a simplified version of the third-party software, so the browser plugin is only capable of processing simple non-webpage information. For complex non-webpage information, the method of the present embodiment supports a manner that the browser plugin calls the third-party software to processes the non-processed information. In that case, the browser plugin has to prejudge whether the browser plugin is capable of processing the non-processed information. If the browser plugin is capable of processing the non-processed information, a step 204 is executed. If the browser plugin is not capable of processing the non-processed information, a step 205 is executed.

In a process of the browser plugin judging whether the browser plugin is capable of processing the non-processed information, for example, the browser plugin judges according to a complexity of the non-processed information. If the complexity is within the scope that the browser plugin can process, the browser plugin judges that the browser plugin is capable of processing the non-processed information. If the complexity is beyond the scope that the browser plugin can process, the browser plugin judges that the browser plugin is not capable of processing the non-processed information. In addition, except judging whether the browser plugin is capable of processing the non-processed information according to the complexity of the non-processed information, there may be other ways to judge whether the browser plugin is capable of processing the non-processed information, and the ways are not limited in the present embodiment.

204: processing the non-processed information using the browser plugin, and the process ends.

In this step, when the browser plugin judges that the browser plugin is capable of processing the non-processed information, the browser plugin processes the information via the network transfer protocol with the server. As the way of processing simple non-webpage information by browser plugins is very mature in the known art, thus the detail process is not described in the present embodiment for the purpose of brief description.

205: calling a corresponding third-party software via the browser plugin, and processing the non-processed information with the third-party software, and the process ends.

Specifically, the third-party software provides the browser plugin to the browser. The third-party software and the browser plugin switch with each other using universal interfaces, and processes non-webpage information. Both of the third-party software and the browser plugin have capability to process the non-webpage information. The difference is that the browser plugin is embedded in the browser. A size of an installation package of the browser plugin is limited, and the database of the browser plugin is a brief version. Similar to the browser plugin, the third-party software also can be embedded in the browser. However, in order to reduce the size of the installation package of the browser, the third-party software and the browser can also be individually installed according to the method of the present embodiment. Then, the third-party software can be called by the browser plugin when there is information needs to be processed. Compared to the browser plugin, the database of the third-party software is more complete, and the capability for processing information is stronger. Calling the corresponding third-party software via the browser plugin, and processing the non-processed information with the third-party software is very mature in the known art, the detail process is not described in the present embodiment for the purpose of a brief description.

In the method of the present embodiment, the browser calls a third-party software via a browser plugin, and submits complex non-webpage information cannot be processed by the browser to the third-party software for processing, and this method expands the scope of the information can be processed by the browser, and improves the information processing capability of the browser. Furthermore, the third-party software and the browser are independent from each other, a size of an installation package of the browser can be reduced, and the health degree of the third-party software can also be improved. Additionally, the interaction of the browser plugin and the third-party software improves the mutual viscous of the third-party software and the browser, as a result, the third-party software get more exposure under the support of the browser.

### Embodiment 3

The present embodiment provides a method for processing information. For describing the method provided by the present embodiment more intuitively, the method provided by the present embodiment is described taking the browser is a really simple syndication (RSS) plugin and the third-party software is a RSS software as an example.

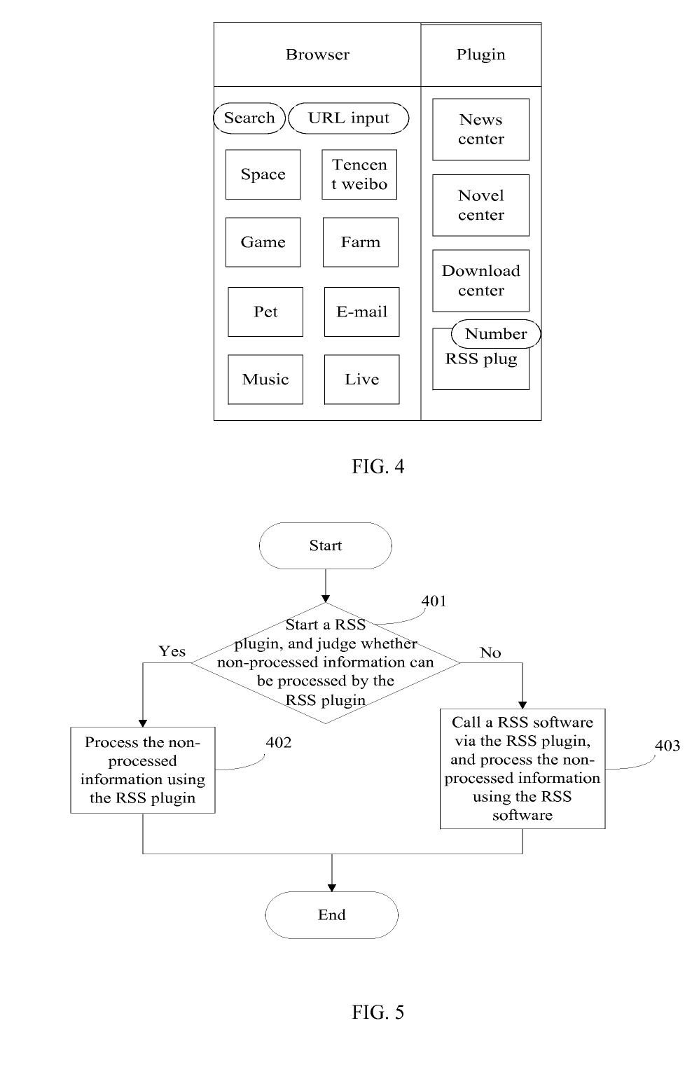

Specifically, after the browser launching the RSS plugin, the RSS plugin is displayed on a sidebar of the browser, as shown in FIG. 4, which is a is a schematic diagram illustrating an interface of a home page of the browser. When the browser is in use, the RSS software automatically checks messages that can be optionally processed by the user. The RSS plugin query the RSS software whether there are unread messages, prompts tips to the user for the number of the unread messages, and displays a prompt box including the number of the unread messages at a top of the RSS plugin shown in FIG. 4. The user may click the RSS plugin to launch the browser for processing and reading the unread messages. In the condition that the unread information is non-webpage information, the browser judges that the non-processed information is non-webpage information; the browser processes the non-processed information via calling the RSS plugin. Referring to FIG. 5, the method provided by the present embodiment includes following steps:

401, after the browser launching the RSS plugin, the RSS plugin judges whether the RSS plugin is capable of processing the non-processed information. If the RSS plugin is capable of processing the non-processed information, a step 402 is executed; otherwise, a step 403 is executed.

The RSS plugin is a widget program provided by a RSS software according to certain application programming interface specification, and is embedded in the browser. The function of the RSS plugin is to process non-webpage information that cannot be processed by the browser. The browser provides a loading way for the RSS plugin, so that the RSS plugin can be loaded into the applications and the network transfer protocols, and exchange data with the browser. The RSS plugin can use the data shared by the browser. The RSS plug-in can use the data shared by the browser.

The RSS plugin may be started when the browser starts, or started by the browser when the browser calls the browser plugin, or started and closed by the users at any time. Ways to start the RSS plugin are not limited in the present embodiment.

After the browser decrypts the encrypted packet, which is sent by the server 3 and received by the browser, and ascertains the packet type, the browser calls the corresponding browser plugin, that is the RSS plugin, according to the packet type. As the RSS plugin is a simplified version of the RSS software, thus the RSS plugin is only capable of processing simple non-webpage information. For complex non-webpage information, the RSS plugin needs to call the RSS software to process the non-processed information. In that case, the RSS plugin has to prejudge whether the RSS plugin is capable of processing the non-processed information. If the RSS plugin is capable of processing the non-processed information, a step 402 is executed. If the RSS plugin is not capable of processing the non-processed information, a step 403 is executed.

In a process of the RSS plugin judging whether the browser plugin is capable of processing the non-processed information, for example, the RSS plugin judges according to a complexity of the non-processed information. If the complexity is within the scope that the RSS plugin can process, the RSS plugin judges that the RSS plugin is capable of processing the non-processed information. If the complexity is beyond the scope that the RSS plugin can process, the RSS plugin judges that the RSS plugin is not capable of processing the non-processed information. In addition, except judging whether the RSS plugin is capable of processing the non-processed information according to the complexity of the non-processed information, there may be other ways to judge whether the browser plugin is capable of processing the non-processed information, and the ways are not limited in the present embodiment.

402: the RSS plugin processes the non-processed information, and the process ends.

In this step, when the RSS plugin judges that the RSS plugin is capable of processing the non-processed information, the RSS plugin processes the information via the network transfer protocol with the server. As the way of processing simple non-webpage information by RSS plugins is very mature in the known art, thus the detail process is not described in the present embodiment for the purpose of brief description.

Step 403: the RSS plugin calls the RSS software, the RSS software processes the non-processed information, and the process ends.

The RSS software provides an easy way to share some contents online. RSS feeds provide by websites is helpful for the user to obtain latest updates in a quick manner. The RSS software provides the RSS plugin to the browser. The RSS software and the RSS plugin switch with each other using universal interfaces, and processes non-webpage information. Both of the RSS software and the RSS plugin have capability to process the non-webpage information. The difference is that the RSS plugin is embedded in the browser. A size of an installation package of the RSS plugin is limited, and the database of the RSS plugin is a brief version. Similar to the RSS plugin, the RSS software also can be embedded in the browser. However, in order to reduce the size of the installation package of the browser, the RSS software and the browser can also be individually installed according to the method of the present embodiment. Then, the RSS software can be called by the RSS plugin when there is information needs to be processed. Compared to the RSS plugin, the database of the RSS software is more complete, and the capability for processing information is stronger. Thus, the messages to be read can be shown to the user using modules already exists in the RSS software when processing the non-processed information using the RSS software. Reading non-process information such as unread messages using a RSS software is very mature in the known art, the detail process is not described in the present embodiment for the purpose of a brief description.

Furthermore, after the third-party software processing the non-processed information, the method provided by the present embodiment further includes a step of returning to a home page of the browser. The way of returning to the home page of the browser is not limited in the present embodiment. In practical applications, the third-party software may provide an entrance for returning to the home page after the third-party software processes the non-processed information, thereby returning to the home page of the browser using the entrance.

In the method of the present embodiment, the browser calls a RSS software via a RSS plugin, and submits complex non-webpage information cannot be processed by the browser to the RSS software for processing, and this method expands the scope of the information can be processed by the browser, and improves the information processing capability of the browser. Furthermore, the RSS software and the browser are independent from each other, a size of an installation package of the browser can be reduced, and the health degree of the RSS software can also be improved. Additionally, the interaction of the RSS plugin and the RSS software improves the mutual viscous of the RSS software and the browser, as a result, the RSS software get more exposure under the support of the browser.

The ordinary skill in the art can understand that all or part of the steps in the aforementioned method embodiments can be realized by related hardware instructed by programs. The programs can be stored in a computer readable storage medium. The programs execute the aforementioned method embodiments. The storage medium may be a disk, an optical disk, a ROM, RAM, etc.

### Embodiment 4

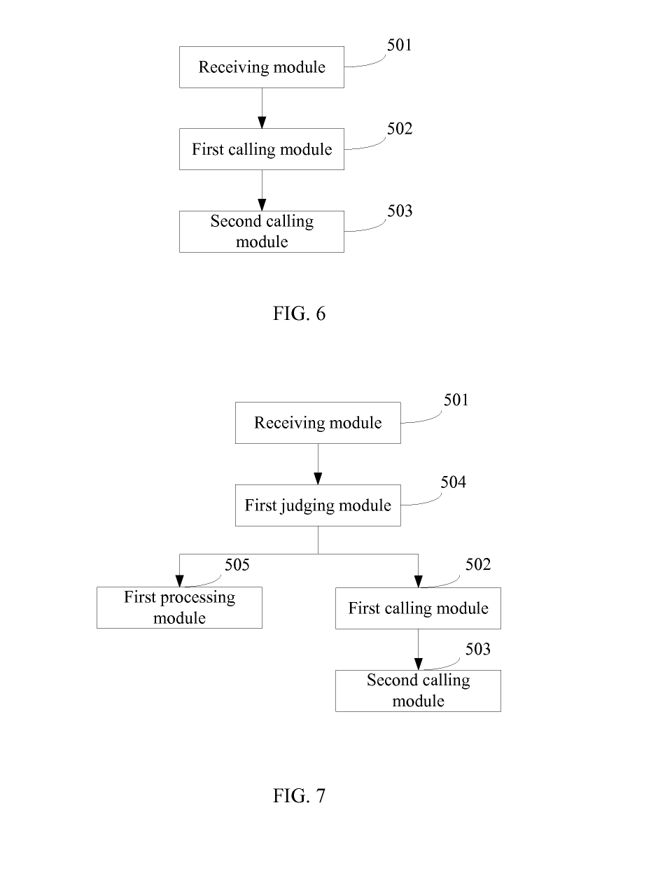

Referring to FIG. 6, the present embodiment provides the electronic device 1 for browsing information from the server 3. A browser is run in the electronic device 1 for executing the methods provided by the aforementioned embodiments 1-3 for processing information. The electronic device 1 includes: a receiving module 501, a first calling module 502, and a second calling module 503.

The receiving module 501 is configured for receiving non-processed information from the server 3.

The first calling module 502 is configured for calling a corresponding browser plugin according to a type of the non-processed information received by the receiving module 501;

The second calling module 503 is configured for calling a corresponding third-party software via the browser plugin called by the first calling module 502, and process the non-processed information with the third-party software.

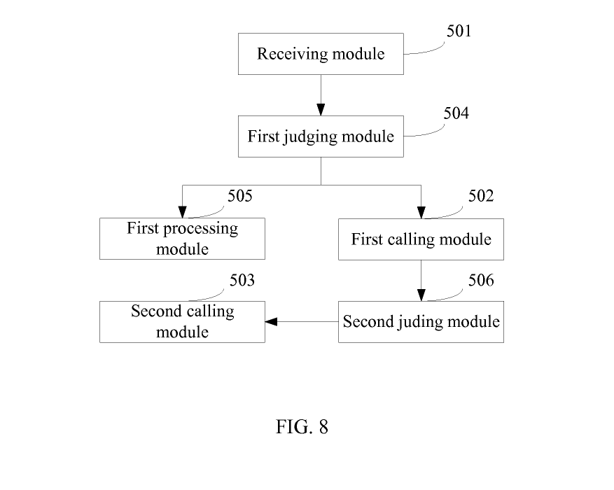

Referring to FIG. 7, the browser further includes a first judging module 504 and a first processing module 505.

The first judging module 504 is configured for judging whether the browser is capable of processing the non-processed information received by the receiving module 501, before the first calling module 502 calls the corresponding the browser plug-in according to the type of the non-processed information;

The first processing module 505 is configured for processing the non-processed information, in the condition that the first judging module 504 judges that the browser is capable of processing the non-processed information received by the receiving module 501;

The first calling module 502 is further configured for calling the corresponding browser plugin according to the type of the non-processed information, in the condition that the first judging module 504 judges that the browser is not capable of processing the non-processed information received by the receiving module 501;

The first judging module 504 is practically configured for judging whether the type of the non-processed information is webpage information. If the type of the non-processed information is webpage information, the first judging module 504 judges that the browser is capable of processing the non-processed information.

Referring to FIG. 8, the browser further includes a second judging module 506.

The second judging module 506 is configured for judging whether the non-processed information can be processed by the browser plugin, before calling the correspond third-party software via the browser plugin;

The second calling module 503 is further configured for processing the non-processed information via the browser plugin, in the condition that the second judging module 506 judges that the non-processed information can be processed by the browser plugin.

The second calling module 503 is further configured for calling the corresponding third-party software via the browser plugin, in the condition that the second judging module 506 judges that the non-processed information cannot be processed by the browser plugin.

According to the browser provided by the present embodiment, the browser calls a third-party software via a browser plugin, and submits complex non-webpage information cannot be processed by the browser to the third-party software for processing, and this method expands the scope of the information can be processed by the browser, and improves the information processing capability of the browser. Furthermore, the third-party software and the browser are independent from each other, a size of an installation package of the browser can be reduced, and the health degree of the third-party software can also be improved. Additionally, the interaction of the browser plugin and the third-party software improves the mutual viscous of the third-party software and the browser, as a result, the third-party software get more exposure under the support of the browser.

It should be noted that the process of the browser provided by the aforementioned embodiment processing the non-processed information is described via the aforementioned division of the functional modules as an example. In practical applications, the above process can be realized by different functional modules according to demand. In other words, internal structure of the browser is divided into several functional modules for realizing all or part of the aforementioned functions. In addition, the browser provided by the aforementioned embodiment and the method embodiments for processing information belongs to the same idea. The implementation process of the browser and the method refers to the method embodiment, and is not repeated here.

The serial numbers of the aforementioned embodiments of the present invention are configured for facilitating description, and do not represent pros and cons of the embodiments.

All or part of the steps in the embodiments of the present invention can be realized by programs. The programs can be stored in a readable storage medium, such as a disk or an optical disk.

The above descriptions are only preferred embodiments of the present invention, and are not intended to limit the present invention. Any modifications, equivalent replacements, and improvements to the embodiments that are within the spirit and the scope of the present invention, should be included in the scope of the present invention.

What is claimed is:

1. A method for processing information, configured for being performed by a browser, the method comprising:
receiving non-processed information from a server;
calling a corresponding browser plugin according to a type of the non-processed information;
calling a corresponding third-party software through the browser plugin; and
processing the non-processed information using the third-party software.

2. The method according to claim 1, before the step of calling a corresponding browser plugin according to a type of the non-processed information, the method further comprising:
judging whether the browser is capable of processing the non-processed information;
if the browser is not capable of processing the non-processed information, the step of calling a corresponding browser plugin according to a type of the non-processed information being executed.

3. The method according to claim 2, the step of judging whether the browser is capable of processing the non-processed information comprising:
judging whether the type of the non-processed information is webpage information;
if the type of the non-processed information is not webpage information, the browser being not capable of processing the non-processed information.

4. The method according to claim 1, before the step of calling a corresponding third-party software through the browser plugin, the method further comprising:
judging whether the browser plugin is capable of processing the non-processed information;
if the browser plugin is not capable of processing the non-processed information, the step of calling a corresponding third-party software through the browser plugin being executed.

5. The method according to claim 1, wherein the step of calling a corresponding third-party software through the browser plugin comprises: calling a corresponding third-party software that is embedded in the browser via the browser plugin.

6. The method according to claim 1, wherein the step of calling a corresponding third-party software through the browser plugin comprises: calling a corresponding third-party software that is independent from the browser.

7. An electronic device for browsing information from a server, the electronic device comprising:
memory;
one or more processors; and
one or more modules stored in the memory and configured for execution by the one or more processors, the one or more modules comprising:
a receiving module, configured for receiving non-processed information from a server;
a first calling module, configured for calling a corresponding browser plugin according to a type of the non-processed information; and
a second calling module, configured for calling a corresponding third-party software through the browser plugin, and processing the non-processed information using the third-party software.

8. The electronic device according to claim 7, further comprising:
a first judging module, configured for judging whether the browser is capable of processing the non-processed information received by the receiving module, before the first calling module calls a corresponding browser plugin according to the type of the non-processed information; and
a first processing module, configured for processing the non-processed information, in the condition that the first judging module judges that the browser is capable of processing the non-processed information received by the receiving module;
the first calling module being further configured for calling the corresponding browser plugin according to the type of the non-processed information, in the condition that the first judging module judges that the browser is not capable of processing the non-processed information received by the receiving module.

9. The electronic device according to claim 8, wherein the first judging module is configured for judging whether the type of the non-processed information is webpage information; and
if the type of the non-processed information is not webpage information, the first judging module judges that browser is not capable of processing the non-processed information.

10. The electronic device according to claim 7, further comprising:
a second judging module, configured for judging whether the browser plugin is capable of processing the non-processed information, before calling a corresponding third-party software through the browser plugin;
a second processing module, configured for processing the non-processed information using the browser plugin, in the condition that the second judging module judges that the browser plugin is capable of processing the non-processed information; and
a second calling module, configured for calling a corresponding third-party software through the browser plugin, in the condition that the second judging module judges that the browser plugin is not capable of processing the non-processed information.

11. A computer readable storage medium storing one or more programs, the one or more programs comprising instructions, which can be executed by an electronic device, cause the electronic device to perform a method comprising:
receiving non-processed information from a server;
calling a corresponding browser plugin according to a type of the non-processed information;
calling a corresponding third-party software through the browser plugin; and
processing the non-processed information using the third-party software.

12. The computer readable storage medium according to claim 11, before the step of calling a corresponding browser plugin according to a type of the non-processed information, the method further comprising:
judging whether the browser is capable of processing the non-processed information;
if the browser is not capable of processing the non-processed information, the step of calling a corresponding browser plugin according to a type of the non-processed information being executed.

13. The computer readable storage medium according to claim 12, the step of judging whether the browser is capable of processing the non-processed information comprising:
judging whether the type of the non-processed information is webpage information;
if the type of the non-processed information is not webpage information, the browser being not capable of processing the non-processed information.

14. The computer readable storage medium according to claim 11, before the step of calling a corresponding third-party software through the browser plugin, the method further comprising:
judging whether the browser plugin is capable of processing the non-processed information;
if the browser plugin is not capable of processing the non-processed information, the step of calling a corresponding third-party software through the browser plugin being executed.

15. The computer readable storage medium according to claim 11, wherein the step of calling a corresponding third-party software through the browser plugin comprises: calling a corresponding third-party software that is embedded in the browser via the browser plugin.

16. The computer readable storage medium according to claim 11, wherein the step of calling a corresponding third-party software through the browser plugin comprises: calling a corresponding a third-party software that is independent from the browser.
